(19) United States
(12) Patent Application Publication
(10) Pub. No.: US 2012/0039626 A1
(43) Pub. Date: Feb. 16, 2012

(54) DEVELOPING CARTRIDGE AND IMAGE FORMING APPARATUS HAVING THE SAME

(75) Inventors: Hyun Ho KIM, Seoul (KR); Ha Na Kim, Seocheon-gun (KR); Jee Su Park, Hwaseong-si (KR)

(73) Assignee: Samsung Electronics Co., Ltd., Suwon-si (KR)

(21) Appl. No.: 13/197,256

(22) Filed: Aug. 3, 2011

(30) Foreign Application Priority Data
Aug. 12, 2010 (KR) 10-2010-0077633

(51) Int. Cl. G03G 21/18; G03G 15/08

(52) U.S. Cl. 399/111; 399/281

(57) ABSTRACT

The image forming apparatus includes a developing cartridge mounted perpendicular to a horizontal printing medium delivery path. The developing cartridge contains a developer storage region, a supply roller, and a developing roller, which are successively arranged from the top to the bottom at one side of an optical path through which a vertically irradiated beam from a light scanning unit reaches a photoconductive medium, thereby ensuring the minimum body size.

### CROSS-REFERENCE TO RELATED APPLICATIONS

This application claims the benefit of Korean Patent Application No. 2010-0077633, filed on Aug. 12, 2010 in the Korean Intellectual Property Office, the disclosure of which is incorporated herein by reference in its entirety.

### BACKGROUND

1. Field of the Invention

Embodiments of the present general inventive concepts relate to an image forming apparatus, a body of which is downsized to ensure a smaller size of the image forming apparatus.

2. Description of the Related Art

Image forming apparatuses are devised to form an image on a printing medium according to input image signals. Examples of image forming apparatuses include printers, copiers, fax machines, and devices combining functions thereof.

An electro-photographic image forming apparatus includes a printing medium supply unit in which printing media is stored, a light scanning unit to irradiate a beam according to an image signal, a developing unit to form a developer image on a printing medium supplied from the printing medium supply unit, a fusing unit to fuse the developer image to the printing medium, and a printing medium discharge unit to discharge the printing medium, on which an image has been completely formed, to the outside.

The above mentioned printing medium supply unit, light scanning unit, developing unit, fusing unit and printing medium discharge unit are appropriately arranged on a printing medium delivery path defined in an apparatus body.

The printing medium delivery path is generally an S-shaped or C-shaped path. In the case of the developing unit, although it is mounted in the body to correspond to the light scanning unit with the printing medium delivery path interposed therebetween, interior components thereof, such as rollers, are generally arranged in a direction parallel to the ground.

The developing unit has a limit as to reduction of a width thereof and therefore, needs appropriate roller arrangement and optical path design to downsize the image forming apparatus.

### SUMMARY

Therefore, it is a feature of the present general inventive concepts to provide an image forming apparatus to minimize a body size.

Additional features of the present general inventive concept will be set forth in part in the description which follows and, in part, will be obvious from the description, or may be learned by practice of the invention.

In accordance with one feature of the present general inventive concepts, an image forming apparatus includes a developing cartridge mounted perpendicular to a horizontal printing medium delivery path and a light scanning unit arranged above the developing cartridge, wherein the developing cartridge contains a developer supply region, a supply roller and a developing roller successively arranged from the top to the bottom at one side of an optical path through which a vertically irradiated beam from the light scanning unit reaches a photoconductive medium.

Developer may fall from the developer supply region to the supply roller.

The developing cartridge may contain a waste developer storage region and a charging roller successively arranged from the top to the bottom at the other side of the optical path.

The supply roller and the developing roller may be arranged above a horizontal line passing through the center of the photoconductive medium.

The center of the supply roller and the center of the developing roller may be aligned in a straight line having an inclination angle of about 45 degrees or more with respect to a horizontal line passing through the center of the photoconductive medium.

The supply roller and the developing roller may be arranged in the second quadrant and the charging roller may be arranged in the first quadrant on the basis of coordinate axes, the origin being the center of the photoconductive medium.

The light scanning unit may include a light source to irradiate a beam according to an image signal, a light deflector to deflect the beam emitted from the light source, and an F-theta lens to correct aberration of the beam deflected by the light deflector, and the image forming apparatus may further include a reflecting mirror to reflect the horizontally irradiated beam from the light scanning unit toward the photoconductive medium.

The reflecting mirror may allow the beam to be scanned to the photoconductive medium at an angle of about 80˜100 degrees with respect to a bottom surface of the body.

The beam scanned from the reflecting mirror to a surface of the photoconductive medium has an angle of about 5˜10 degrees with respect to a vertical direction.

The image forming apparatus may further include a printing medium supply tray coupled to one side of the body so as to be rotatable up and down to enable stacking of printing media thereon, a pickup roller to pick up the printing media stacked on the printing medium supply tray one sheet at a time, a delivery roller to align a tip end of a printing medium picked up by the pickup roller, and a transfer roller to press the printing medium supplied by the delivery roller toward the photoconductive medium, and the printing medium delivery path, which extends through the delivery roller and the transfer roller, may have an angle of at least about 45 degrees with respect to a final optical path of the beam scanned to the photoconductive medium.

The light scanning unit, the developer supply region, the supply roller and the developing roller may be arranged at one side of the optical path.

In accordance with another feature of the present general inventive concepts, an image forming apparatus includes a body, a printing medium delivery path defined in the body to allow a printing medium to be delivered in a direction parallel to the ground, a printing medium supply unit to supply a printing medium to the printing medium delivery path, the printing medium supply unit including a printing medium supply tray coupled to one side of the body so as to be rotatable up and down and a delivery roller to align a tip end of the printing medium supplied from the printing medium supply tray, a developing cartridge separably mounted in the body in a direction perpendicular to the printing medium delivery path to form an image on the printing medium delivered from the printing medium supply unit, and a light scanning unit arranged above the developing cartridge and including a light source to irradiate a beam according to image information, a light deflector to deflect the beam emitted from the light source, an F-theta lens to correct aberration of the beam deflected by the light deflector, and a reflecting mirror to reflect the horizontally irradiated beam from the F-theta lens in a vertical direction, wherein the developing cartridge includes a housing in which a developer supply region, a supply roller, a developing roller, a photoconductive medium, a charging roller and a waste developer storage region are provided, the developer supply region, the supply roller and the developing roller being successively arranged from the top to the bottom at one side of an optical path through which the vertically irradiated beam from the light scanning unit reaches the photoconductive medium, and the charging roller and the waste developer storage region being arranged at the other side of the optical path.

Developer may fall from the developer supply region to the supply roller.

The supply roller and the developing roller may be arranged above a horizontal line passing through the center of the photoconductive medium.

The center of the supply roller and the center of the developing roller may be aligned in a straight line having an inclination angle of about 45 degrees or more with respect to a horizontal line passing through the center of the photoconductive medium.

The supply roller and the developing roller may be arranged in the second quadrant and the charging roller is arranged in the first quadrant on the basis of coordinate axes, the origin being the center of the photoconductive medium.

The light scanning unit may be arranged in the second quadrant.

The beam vertically scanned by the reflecting mirror may have an angle of about 80˜100 degrees with respect to a bottom surface of the body.

The beam scanned from the reflecting mirror to a surface of the photoconductive medium may have an angle of about 5˜10 degrees with respect to a vertical direction.

The image forming apparatus may further include a transfer roller to press the printing medium supplied by the delivery roller toward the photoconductive medium, and the printing medium delivery path, which extends through the delivery roller and the transfer roller, may have an angle of at least about 45 degrees with respect to a final optical path of the beam scanned to the photoconductive medium.

In accordance with a further feature of the present general inventive concepts, a developing cartridge, mounted perpendicular to a horizontal printing medium delivery path defined in a body, includes a developer supply region, a supply roller and a developing roller successively arranged from the top to the bottom at one side of an optical path through which a vertically irradiated beam from a light scanning unit reaches a photoconductive medium.

Developer may fall from the developer supply region to the supply roller.

The developing cartridge may further include a waste developer storage region and a charging roller successively arranged from the top to the bottom at the other side of the optical path.

The supply roller and the developing roller may be arranged above a horizontal line passing through the center of the photoconductive medium.

The center of the supply roller and the center of the developing roller may be aligned in a straight line having an inclination angle of about 45 degrees or more with respect to a horizontal line passing through the center of the photoconductive medium.

The supply roller and the developing roller may be arranged in the second quadrant and the charging roller may be arranged in the first quadrant on the basis of coordinate axes, the origin being the center of the photoconductive medium.

The optical path may be provided to allow the beam to be scanned from the light scanning unit to a surface of the photoconductive medium at an angle of about 5˜10 degrees with respect to a vertical direction.

### BRIEF DESCRIPTION OF THE DRAWINGS

These and/or other features of the present general inventive concept will become apparent and more readily appreciated from the following description of the embodiments, taken in conjunction with the accompanying drawings of which:

FIG. 1 is a sectional view of an image forming apparatus according to an embodiment of the present general inventive concepts;

FIG. 2 is an explanatory view of an optical path according to the embodiment of the present general inventive concepts;

FIGS. 3A and 3B illustrate explanatory views of a relationship between the optical path and a printing medium delivery path according to various embodiments of the present general inventive concepts; and

FIG. 4 is a sectional view illustrating a developing cartridge of the image forming apparatus according to the embodiment of the present general inventive concepts.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, an image forming apparatus according to an exemplary embodiment of the present general inventive concepts will be described in detail with reference to the accompanying drawings.

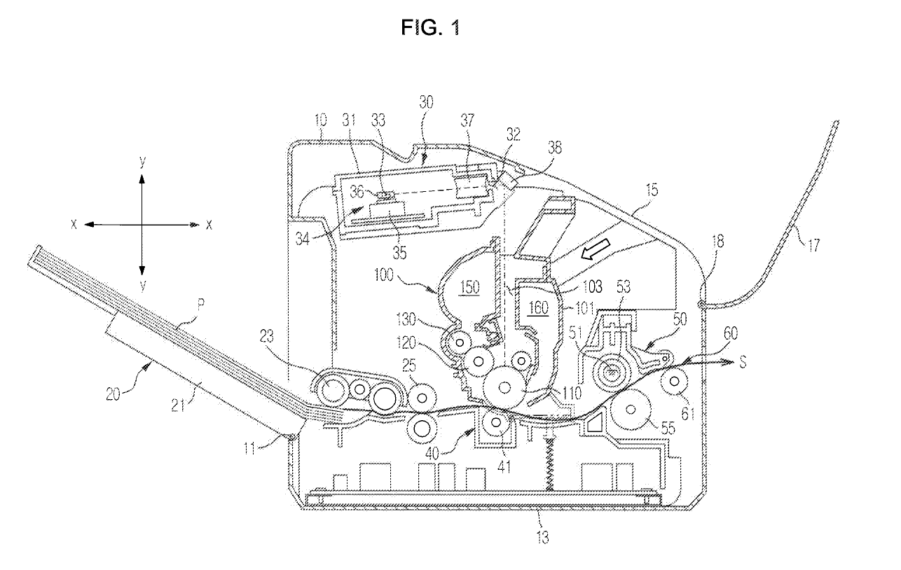

FIG. 1 is a sectional view of the image forming apparatus according to the embodiment of the present general inventive concepts. In FIG. 1, the x-axis represents a horizontal direction when viewed from the lateral side of the image forming apparatus, and the y-axis represents a vertical direction of the image forming apparatus perpendicular to the x-axis.

Referring to FIG. 1, the image forming apparatus 100 may include a body 10, which defines an external appearance of the image forming apparatus 100 and supports a variety of elements therein.

The body 10 may contain a printing medium supply unit 20, a developing cartridge 100, a light scanning unit 30, a transfer unit 40, a fusing unit 50, and a printing medium discharge unit 60.

The printing medium supply unit 20, the developing cartridge 100, the transfer unit 40, the fusing unit 50, and the printing medium discharge unit 60, which are mounted in the body 10, may be substantially parallel to one another in a horizontal direction, so as to define an approximately horizontal printing medium delivery path S.

The printing medium supply unit 20 serves to supply a printing medium P toward the developing cartridge 100.

The printing medium supply unit 20 may include a printing medium supply tray 21 in which printing media P are stacked, a pickup roller 23 to pick up the printing media P stacked in the printing medium supply tray 21 one sheet at a time, and a pair of delivery rollers 25 to accurately align a tip end of the picked-up printing medium P and deliver the printing medium P toward the developing cartridge 100.

The printing medium supply tray 21 may be coupled to one side of the body 10 so as to be pivotally rotatable upward and downward about a hinge shaft 11.

The printing medium supply tray 21, which has been installed as described above, occupies only a smaller volume of the body 10, thus enabling a size reduction (in the y-axis direction) of the body 10.

The developing cartridge 100 may be separably mounted in the body 10. Thus, the developing cartridge 100 may be attached to the body 10 to be mounted in the body 10, and may also be detached from the body 10.

The developing cartridge 100 may include a housing 101, in which main elements to perform a developing process, such as a photoconductive medium 110, a developing roller 120, a supply roller 130, and a charging roller 140, are mounted.

The housing 101 may be oriented substantially perpendicularly to a bottom surface 13 of the body 10, to enable a size reduction (in an x-axis direction) of the body 10. The interior of the housing 101 may be divided into a developer supply region 150 to supply developer, and a waste developer storage region 160 to store waste developer collected from the photoconductive medium 110.

To this end, the body 10 may be provided at an upper portion thereof with an opening 15 for entrance/exit of the developing cartridge 100, and a cover 17 may be rotatably coupled to the body 10 via a cover hinge 18 to open or close the opening 15 with the cover 17.

More specifically, the developing cartridge 100 is inserted into the body 10 in the direction of the force of gravity substantially perpendicular to the horizontal printing medium delivery path S through the opening 15. This enables a remarkable size reduction (in the x-axis direction) of the body 10 as compared to an imaging forming apparatus with an &shaped or C-shaped printing medium delivery path. This configuration of the developing cartridge 100 will be described hereinafter in detail.

The light scanning unit 30 forms an electrostatic latent image on the photoconductive medium 110 by irradiating a beam according to image information of an output object.

The light scanning unit 30 may be located above the vertically oriented developing cartridge 100 in the body 10, to irradiate a beam in a direction substantially perpendicular to a tangential direction of the photoconductive medium 110, e.g., in the y-axis direction substantially perpendicular to the bottom surface 13 of the body 10.

The light scanning unit 30 may include a case 31, a light source 33 to irradiate a beam according to an image signal, a light deflector 34 to deflect the beam emitted from the light source 33, and an F-theta lens 37 to focus the deflected beam on the photoconductive medium 110, all of the light source 33, the light deflector 34 and the F-theta lens 37 being mounted in the case 31.

The light source 33 may include a laser diode to irradiate a laser beam, and the light deflector 34 may include a polygonal mirror 36 that is rotated by a drive motor 35.

The polygonal mirror 36 has a plurality of reflecting faces to deflect and scan the incident beam from the light source 33. The F-theta lens 37 may horizontally scan the deflected and scanned beam through a beam emission port 32 of the case 31.

A reflecting mirror 38 may be provided in front of the beam emission port 32 and serve to reflect the horizontally scanned beam from the light scanning unit 30 in a substantially vertical direction.

The beam reflected by the reflecting mirror 38 may be scanned through an optical path 103 defined in the developing cartridge 100 to a surface of the photoconductive medium 110 in a direction substantially perpendicular to the bottom surface 13.

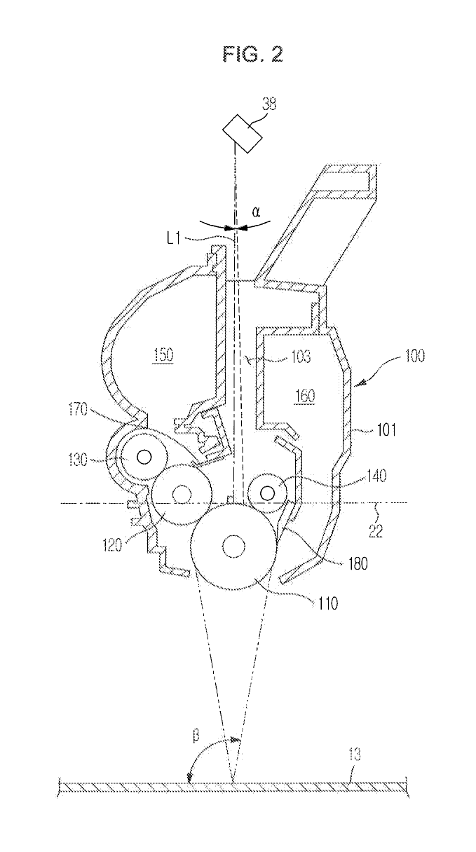

The reflecting mirror 38 may be oriented to reflect the horizontally scanned beam from the light scanning unit 30 in a direction substantially perpendicular to the ground. More particularly, the reflecting mirror 38 may allow the horizontally scanned beam to be scanned to the surface of the photoconductive medium 110 at an angle β of 80˜100 degrees with respect to the bottom surface 13 of the body 10 (see FIG. 2). This orientation serves to reduce the size of the body 10 within an optimum range.

As illustrated in FIG. 2, the beam, which is vertically scanned from the reflecting mirror 38 to the surface of the photoconductive medium 110, may not be completely perpendicular to a vertical direction (i.e. the first dashed dot line L1 perpendicular to the second dashed dot line L2 in a tangential direction of the photoconductive medium 100 parallel to the ground or the horizontal line). For example, the beam may have an angle β of 5˜10 degrees with respect to the vertical direction.

This serves to prevent interference between a beam irradiated to the photoconductive medium 110 and a beam reflected from the surface of the photoconductive medium 110 and also, to minimize the size of the body 10.

The optical path 103 is defined by a vertical passage of the housing 101 through which the photoconductive medium 110 communicates with the outside of the housing 101, thereby serving as a path through which the beam vertically reflected by the reflecting mirror 38 reaches the photoconductive medium 110.

When separately arranging the reflecting mirror 38 at the outside of the case 31 of the light scanning unit 30, a conventional light scanning unit devised to irradiate a beam horizontally may be used without additional design change, resulting in cost reduction and simplification.

It is further noted that the conventional light scanning unit devised to irradiate a beam horizontally to a photoconductive medium may need a relatively long beam scanning distance in order to output a high resolution image, thus limiting the degree to which the size of the image forming apparatus may be reduced. For example, in order to achieve the high resolution image, a conventional light scanning unit may be disposed such that the beam from the light source 33 travels a long distance until it reaches a photoconductive medium. Thus, a size of a conventional image forming apparatus using the conventional light scanning unit may be determined by the distance that the beam travels, and thus may increase horizontally (e.g. in the x-axis direction) as the distance becomes longer in a horizontal direction.

However, in the image forming apparatus according to the present embodiment, the horizontally scanned beam from the light scanning unit 30 is vertically scanned, i.e. so as to define an L-shaped beam path, because the beam from the light source 33 is reflected by the reflecting mirror 38 to change the beam's direction from a substantially horizontal direction to a substantially vertical direction. This may prevent the light scanning unit 30 from greatly occupying the interior of the body 10, enabling a size reduction (in the x-axis direction) of the body 10.

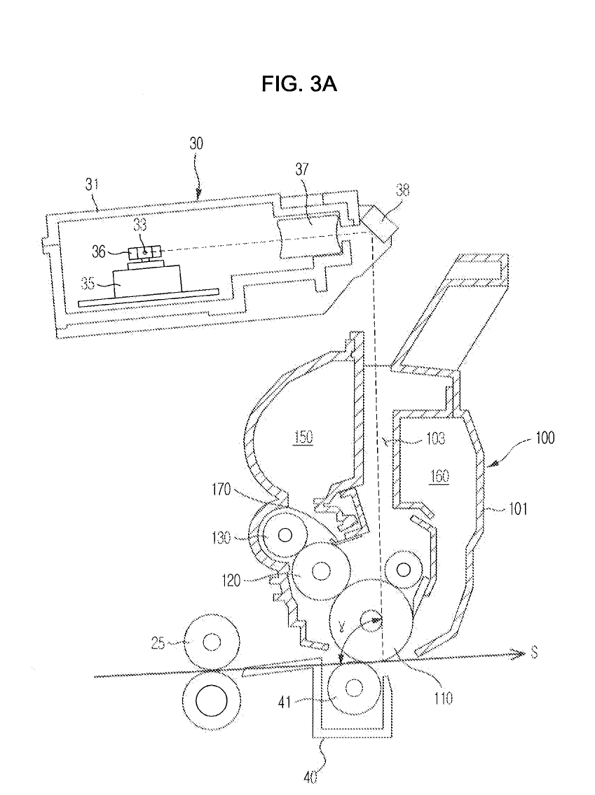

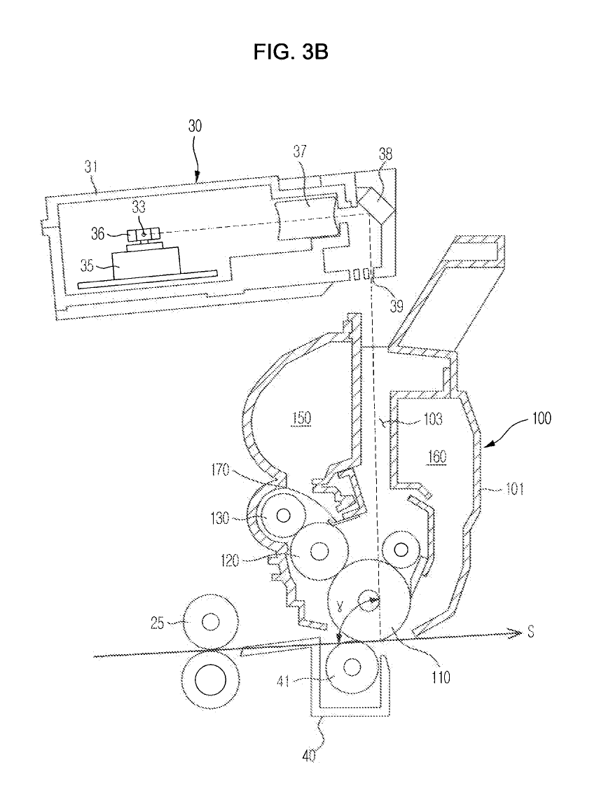

FIGS. 3A and 3E3 illustrate explanatory views of a relationship between the optical path 103 and the printing medium delivery path S according to various embodiments of the present general inventive concepts. The horizontal printing medium delivery path S may be defined in the body 10 to have an angle γ of at least 45˜90 degrees with a final optical path of the beam substantially perpendicular to the photoconductive medium 110 (see FIG. 3A).

A detailed process of printing an image to the printing medium P is explained as follows. The transfer unit 40 serves to transfer a visible developer image formed on the photoconductive medium 110 to the printing medium P. The visible developer image may be formed on the photoconductive medium 110 when the developer is applied to the photoconductive medium 110 by the developing roller 120 after the irradiated beam is scanned to the photoconductive medium 110.

The transfer unit 40 may include a transfer roller 41 to press the printing medium P toward the photoconductive medium 110, thereby allowing the visible developer image formed on the photoconductive medium 110 to be transferred to the surface of the printing medium P.

The transfer roller 41 may be positioned to come into contact with the photoconductive medium 110 of the developing cartridge 110 mounted in the body 10 when the printing medium P is not disposed between the transfer roller 41 and the photoconductive medium 110.

The above described embodiment of FIGS. 1 and 3A describes the reflecting mirror 38 as being provided independently of the light scanning unit 30. In another embodiment, as illustrated in FIG. 3B, the reflecting mirror 38 may be received in the case 31 such that the reflecting mirror 38 is inside the case 31 and the beam emission port may be located in the bottom of the case 31 as a perforated portion 39 such that the beam reflected on the reflecting mirror 38 can travel through the perforated portion 39 to reach the photoconductive medium 110.

Referring back to FIG. 1, the fusing unit 50 serves to fuse the developer image on the printing medium P by applying heat and pressure to the printing medium P.

The fusing unit 50 may include a heating member 53 containing a heat source 51 and a press roller 55 to press the printing medium P toward the heating member 53.

The heating member 53 may take a form of a roller containing the heat source 51, or may take a form of a belt heated by the heat source 51.

The press roller 55 may be supported by an elastic member (not shown) so as to come into close contact with the heating member 53 to thereby maintain a constant fusing pressure between the press roller 55 and the heating member 53. For example, the press roller 55 may be covered with an elastic material such that the press roller 55 may experience an elastic contact against the heating member 53.

In this way, as the fusing unit 50 applies heat and pressure to the visible developer image that has been transferred to the printing medium P while the printing medium P passes between the heating member 53 and the press roller 55, the visible image is fused to the printing medium P.

The printing medium discharge unit 60 includes at least one discharge roller 61 to discharge the printing medium P, having passed through the fusing unit 50, to the outside of the body 10.

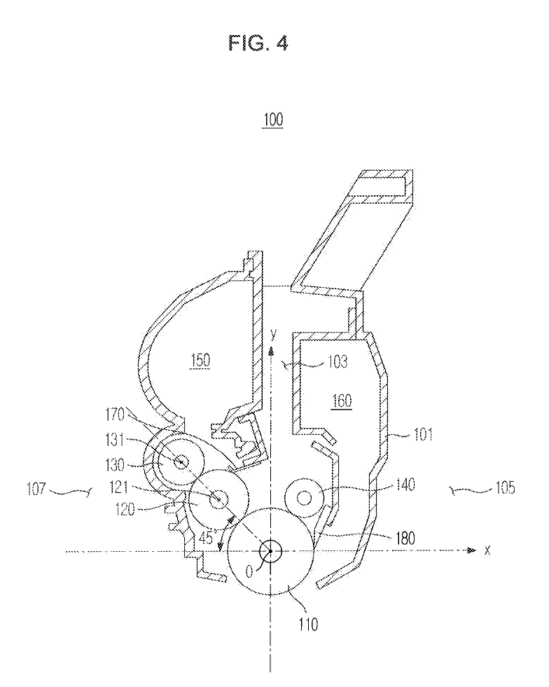

FIG. 4 is a sectional view illustrating the developing cartridge according to the embodiment of the present general inventive concepts.

Referring to FIG. 4, the developing cartridge 100 may include the housing 101 defining an external appearance of the developing cartridge 100. Main elements to perform a developing process, i.e. the photoconductive medium 110, the developing roller 120, the supply roller 130, and the charging roller 140 are mounted in the housing 101 to construct a single process cartridge.

The interior of the housing 101 may be divided into a developer supply region 150 to supply developer, and a waste developer storage region 160 to store waste developer collected from the photoconductive medium 110.

The developer supply region 150 and the waste developer storage region 160 may be arranged at opposite sides of the optical path 103 through which the beam irradiated from the light scanning unit 30 reaches the photoconductive medium 110.

The photoconductive medium 110 may have a drum shape and serve as an image carrier to carry a developer image. The photoconductive medium 110 may be a rotating drum whose rotation corresponds with rotation of the developing roller 120 as well as the rate the beam irradiated from the light scanning unit 30 is scanned to the photoconductive medium 110.

The light scanning unit 30 irradiates a laser beam to the photoconductive medium 110 according to image information, thereby allowing an electrostatic latent image to be formed on the surface of the photoconductive medium 110. For example, as the photoconductive medium 110 rotates, the laser beam is irradiated to the photoconductive medium 110 according to the image information, wherein the width of the photoconductive medium is at least the width of the image of the image information.

The charging roller 140 applies electric charge to the photoconductive medium 110 while being rotated in contact with the surface of the photoconductive medium 110, thereby charging the surface of the photoconductive medium 110 with a predetermined potential.

The developing roller 120 supplies developer to the photoconductive medium 110 to develop the electrostatic latent image formed on the photoconductive medium 110 to a developer image. For example, when the developer from the developing roller 120 is supplied to the photoconductive medium 110 according to the electrostatic latent image on the photoconductive medium 110, so as to form the developer image.

The supply roller 130 supplies the developer stored in the developer supply region 150 to the developing roller 120. For example, the supply roller may pick up the developer in the developer supply region 150, and then transfer the developer onto the developing roller 120.

The developer supplied to the developing roller 120 may define a developer layer having a constant thickness under operation of a regulating member 170. For example, the regulating member 170 may maintain a constant thickness of the developer layer of the developer on the developing roller 120 by removing excess developer.

In this way, if the light scanning unit 30 forms an electrostatic latent image on the surface of the photoconductive medium 110 that has been charged with the predetermined potential by the charging roller 140, the developer stored in the developer supply region 150 is supplied to the photoconductive medium 110 by the supply roller 130 and the developing roller 120, thereby allowing a visible developer image composed of powdered developer to be formed on the photoconductive medium 110 according to the electrostatic latent image.

After the transfer unit 40 (see FIG. 1) transfers the visible developer image formed on the photoconductive medium 110 to the printing medium P, a cleaning blade 180 removes the residue of the developer from the photoconductive medium 100 and the removed residue of developer is collected into the waste developer storage region 160.

In the meantime, the supply roller 130, the developing roller 120 and the charging roller 140, which are arranged in the housing 101, may be located above a horizontal line (the x-axis) passing through the center O of the photoconductive medium 110. For example, the center O may be located at an axis about which the photoconductive medium 110 rotates.

Specifically, when viewed in the x-axis and y-axis directions, the origin being the center O of the photoconductive medium 110, the supply roller 130 and the developing roller 120 may be arranged in the second quadrant 107, and the charging roller 140 may be arranged in the first quadrant 105.

In relation to the second quadrant 107, a center 131 of the supply roller 130 may be located higher than a center 121 of the developing roller 120. The center 131 may be an axis about which the supply roller 130 rotates, and the center 121 may be an axis about which the developing roller 120 rotates.

The supply roller 130, the developing roller 120 and the photoconductive medium 110, which are provided in the housing 101, may be successively arranged from the top to the bottom in a vertical direction (the y-axis direction). This arrangement enables a size reduction in the width direction (the x-axis direction) of the developing cartridge 100.

The developer supply region 150 is located above the supply roller 130 and thus, the developer falls from the developer supply region 150 to the supply roller 130 and subsequently, to the photoconductive medium 110. Thus, the developer supply region 150 does not need an agitator to agitate or deliver the developer, enabling a reduction in the width of the housing 101.

In this case, the center 131 of the supply roller 130 and the center 121 of the developing roller 120 located below the center 131 of the supply roller 130 may be aligned in a straight line that passes through the center O of the photoconductive medium 110. In one example, this straight line may have an inclination angle of 45 degrees or more with respect to the horizontal line x passing through the center O of the photoconductive medium 110.

This ensures not only smooth supply of the developer from the developer supply region 150 to the photoconductive medium 110 without an agitator, but also an optimized size of the developing cartridge 100.

Further, when the developer supply region 150 has no agitator to deliver the developer to the supply roller 130, it may be possible to prevent stress applied by the agitator continuously in the form of pressure to the developer.

With the above described configuration, on the basis of the optical path 103 through which the beam is scanned from the top to the bottom of the body 10, the light scanning unit 30, the developer supply region 150, the supply roller 130 and the developing roller 120 may be arranged at one side of the body 10, and the waste developer storage region 160 and the charging roller 140 may be arranged at the other side of the body 10.

More particularly, the developer supply region 150, the supply roller 130 and the developing roller 120 may be successively arranged from the top to the bottom in a partial region of the housing 101 at one side of the optical path 103, in order to reduce the size of the developing cartridge 100.

As a result, the developing cartridge 100 may realize a remarkable width reduction (e.g. reduction in size in the x-axis), and in turn, vertically orienting the developing cartridge 100 having a remarkably reduced width in the body 10 having the horizontal printing medium delivery path S may realize a remarkable reduction in the size of the body 10, resulting in improved productivity owing to reduced material costs.

Furthermore, when the main developing elements of the developing cartridge 100, i.e. the photoconductive medium 110, the charging roller 140, the developing roller 120, the supply roller 130, the developer supply region 150 and the waste developer storage section 160 construct a single process cartridge, it may be possible to eliminate a variety of electric elements from the body 10, and this may reduce Electro-Magnetic Interception (EMI).

As is apparent from the above description, an image forming apparatus according to the embodiment of the present general inventive concepts may minimize a body size.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An image forming apparatus comprising:
a developing cartridge mounted perpendicular to a horizontal printing medium delivery path; and
a light scanning unit arranged above the developing cartridge,
wherein the developing cartridge contains a developer supply region, a supply roller and a developing roller that are successively arranged from a top to a bottom at one side of an optical path through which a vertically irradiated beam from the light scanning unit reaches a photoconductive medium.

2. The apparatus according to claim 1, wherein a developer falls from the developer supply region to the supply roller.

3. The apparatus according to claim 1, wherein the developing cartridge contains a waste developer storage region and a charging roller that are successively arranged from a top to a bottom at another side of the optical path.

4. The apparatus according to claim 1, wherein the supply roller and the developing roller are arranged above a horizontal line passing through a center of the photoconductive medium.

5. The apparatus according to claim 1, wherein a center of the supply roller and a center of the developing roller are aligned in a straight line having an inclination angle of about 45 degrees or more with respect to a horizontal line passing through a center of the photoconductive medium.

6. The apparatus according to claim 3, wherein the supply roller and the developing roller are arranged in a second quadrant and the charging roller is arranged in a first quadrant on a basis of axes of a coordinate, an origin of the coordinate being a center of the photoconductive medium.

7. The apparatus according to claim 1, wherein:
the light scanning unit includes a light source to irradiate a beam according to an image signal, a light deflector to deflect the beam irradiated from the light source, and an F-theta lens to correct aberration of the beam deflected by the light deflector; and
the image forming apparatus further comprises a reflecting mirror to reflect the horizontally irradiated beam from the light scanning unit toward the photoconductive medium.

8. The apparatus according to claim 7, wherein the reflecting mirror allows the irradiated beam to be scanned to the photoconductive medium at an angle of about 80˜100 degrees with respect to a bottom surface of the body.

9. The apparatus according to claim 7, wherein the beam reflected from the reflecting mirror to a surface of the photoconductive medium has an angle of about 5˜10 degrees with respect to a vertical direction.

10. The apparatus according to claim 1, further comprising:
a printing medium supply tray coupled to one side of the body so as to be rotatable up and down to enable stacking of printing media thereon;
a pickup roller to pick up the printing media stacked on the printing medium supply tray one sheet at a time;
a delivery roller to align a tip end of a printing medium picked up by the pickup roller; and
a transfer roller to press the printing medium supplied by the delivery roller toward the photoconductive medium,
wherein the printing medium delivery path, which extends through the delivery roller and the transfer roller, has an angle of at least about 45 degrees with respect to a final optical path of the beam scanned to the photoconductive medium.

11. The apparatus according to claim 7, wherein the light scanning unit is arranged at one side of the optical path.

12. An image forming apparatus comprising:
a body;
a printing medium delivery path defined in the body to allow a printing medium to be delivered in a direction parallel to a ground;
a printing medium supply unit to supply a printing medium to the printing medium delivery path, the printing medium supply unit including a printing medium supply tray coupled to one side of the body so as to be rotatable up and down and a delivery roller to align a tip end of the printing medium supplied from the printing medium supply tray;
a developing cartridge separably mounted in the body in a direction perpendicular to the printing medium delivery path to form an image on the printing medium delivered from the printing medium supply unit; and
a light scanning unit arranged above the developing cartridge and including a light source to irradiate a beam according to image information, a light deflector to deflect the beam emitted from the light source, an F-theta lens to correct aberration of the beam deflected by the light deflector, and a reflecting mirror to reflect the horizontally irradiated beam from the F-theta lens in a vertical direction,
wherein the developing cartridge includes a housing in which a developer supply region, a supply roller, a developing roller, a photoconductive medium, a charging roller and a waste developer storage region are provided, the developer supply region, the supply roller and the developing roller being successively arranged from a top to a bottom at one side of an optical path through which the vertically irradiated beam from the light scanning unit reaches the photoconductive medium, and the charging roller and the waste developer storage region being arranged at another side of the optical path.

13. The apparatus according to claim 12, wherein a developer falls from the developer supply region to the supply roller.

14. The apparatus according to claim 13, wherein the supply roller and the developing roller are arranged above a horizontal line passing through a center of the photoconductive medium.

15. The apparatus according to claim 13, wherein a center of the supply roller and a center of the developing roller are aligned in a straight line having an inclination angle of about 45 degrees or more with respect to a horizontal line passing through a center of the photoconductive medium.

16. The apparatus according to claim 13, wherein the supply roller and the developing roller are arranged in a second quadrant and the charging roller is arranged in a first quadrant on a basis of axes of a coordinate, the origin of a coordinate being a center of the photoconductive medium.

17. The apparatus according to claim 16, wherein the light scanning unit is arranged in the second quadrant.

18. The apparatus according to claim 13, wherein the beam vertically reflected by the reflecting mirror has an angle of about 80˜100 degrees with respect to a bottom surface of the body.

19. The apparatus according to claim 13, wherein the beam reflected from the reflecting mirror to a surface of the photoconductive medium has an angle of about 5˜10 degrees with respect to a vertical direction.

20. The apparatus according to claim 13, further comprising a transfer roller to press the printing medium supplied by the delivery roller toward the photoconductive medium,
wherein the printing medium delivery path, which extends through the delivery roller and the transfer roller, has an angle of at least about 45 degrees with respect to a final optical path of the beam scanned to the photoconductive medium.

21. A developing cartridge mounted perpendicular to a horizontal printing medium delivery path defined in a body,
wherein the developing cartridge comprises a developer supply region, a supply roller and a developing roller that are successively arranged from a top to a bottom at one side of an optical path through which a vertically irradiated beam from a light scanning unit reaches a photoconductive medium.

22. The developing cartridge according to claim 21, wherein a developer falls from the developer supply region to the supply roller.

23. The developing cartridge according to claim 21, wherein the developing cartridge further comprises a waste developer storage region and a charging roller successively arranged from the top to the bottom at the other side of the optical path.

24. The developing cartridge according to claim 21, wherein the supply roller and the developing roller are arranged above a horizontal line passing through a center of the photoconductive medium.

25. The developing cartridge according to claim 21, wherein a center of the supply roller and a center of the developing roller are aligned in a straight line having an inclination angle of about 45 degrees or more with respect to a horizontal line passing through a center of the photoconductive medium.

26. The developing cartridge according to claim 23, wherein the supply roller and the developing roller are arranged in a second quadrant and the charging roller is arranged in a first quadrant on the basis of axes of a coordinate, the origin of the coordinate being the center of the photoconductive medium.

27. The developing cartridge according to claim 21, wherein the optical path is provided to allow the beam to be scanned from the light scanning unit to a surface of the photoconductive medium at an angle of about 5˜10 degrees with respect to a vertical direction.

28. An image forming apparatus comprising:
a light scanning unit to irradiate a light beam according to image information, the light scanning unit comprising:
a light source to irradiate a beam according to image information, and
a light redirector to receive the beam and to redirect the beam in a different direction;
a developing cartridge mounted below the light scanning unit, the developing cartridge comprising:
a photoconductive medium,
an optical path through which the beam redirected by the light redirector reaches the photoconductive medium,
a developer supply region to supply a developer to the photoconductive medium, and
a waste developer storage region to store waste developer from the photoconductive medium,
wherein the developer supply region, the supply roller, the developer roller and the photoconductive medium, among which the developing supply region is closest to the light scanning unit, are successively arranged along the optical path.

29. The image forming apparatus of claim 28, further comprising:
a charging roller to apply electric charge to the photoconductive medium,
wherein the waste developer storage region, the charging roller and the photoconductive medium, among which the waste developer storage region is closest to the light scanning unit, are successively arranged along the optical path.
